(19) United States
(12) Patent Application Publication
(10) Pub. No.: US 2015/0364888 A1
(43) Pub. Date: Dec. 17, 2015

(54) METHOD FOR MANUFACTURING ELECTRICAL CONNECTOR WITH MULTIPLE INJECT-MOLDING PROCESSES

(71) Applicant: ALLTOP ELECTRONICS (SUZHOU) LTD., Taicang City (CN)

(72) Inventors: Wang-I YU, Jhonghe City (TW); Mao-Jung HUANG, Jhonghe City (TW); Li-Li LIANG, Jhonghe City (TW); Yong-Gang ZHANG, Jhonghe City (TW); Kun LIU, Jhonghe City (TW)

(73) Assignee: ALLTOP ELECTRONICS (SUZHOU) LTD., Taicang City (CN)

(21) Appl. No.: 14/559,185

(22) Filed: Dec. 3, 2014

(30) Foreign Application Priority Data
Jun. 11, 2014 (CN) 201420308487.5
Sep. 3, 2014 (CN) 201410444992.7

(51) Int. Cl. H01R 43/00

(52) U.S. Cl. CPC H01R 43/00

(57) ABSTRACT

A method for making an electrical connector include steps of: S1) providing a plurality of upper contacts and inject-molding an upper housing over the upper contacts so as to form an upper contact module; S2) providing a plurality of lower contacts and inject-molding a lower housing over the lower contacts so as to form a lower contact module; and S3) inject-molding an outer insulative housing over the upper contact module and the lower contact module.

### CROSS REFERENCE TO RELATED APPLICATIONS

The present application claims the priority of Chinese patent application Ser. No. 201410444992.7 filed Sep. 3, 2014 in the SIPO (Sate Intellectual Property Office of the P.R.C.), which is incorporated by reference herein in its entirety.

### BACKGROUND

1. Technical Field

The present disclosure relates to a method for making an electrical connector, and more particularly to a method have three inject-molding process for making the electrical connector.

2. Description of Related Art

A conventional I/O connector for being mounted to a circuit board usually includes an insulative housing, a plurality of contacts retained in the insulative housing and an outer shell enclosing the insulative housing. The insulative housing usually includes a base and a tongue portion extending from the base. Since the tongue portion is usually thinner than the base, the strength of the tongue portion maybe not strong enough. In order to solve this problem, an inner shell is provided. Usually, such inner shell is of an annular shape through which the insulative housing extends. The inner shell can not only improve the strength of the insulative housing but also realize robust shielding effect. For this reason, it is crucial to fasten the inner shell with the insulative housing.

Nowadays, the inner shell is usually formed by stretch molding technology which requires rigorous moulds and complex structures. Usually, in designing the stretch moulds, in order to easily manufacture the inner shell, the R angle of the punish needs to be designed much larger than the actual dimension. Under this condition, it is difficult to stably fix the inner shell to the insulative housing because its dimension is somehow much bigger. Besides, the inner shell manufactured through the stretch molding technology probably has weak strength and may easily get deformed.

Hence, it is desirable to provide an improved method for making electrical connectors.

### SUMMARY

The present disclosure provides a method for making an electrical connector comprising steps of:
S1) providing a plurality of upper contacts and inject-molding an upper housing over the upper contacts so as to form an upper contact module;
S2) providing a plurality of lower contacts and inject-molding a lower housing over the lower contacts so as to form a lower contact module; and

S3) inject-molding an outer insulative housing over the upper contact module and the lower contact module.

The foregoing has outlined rather broadly the features and technical advantages of the present disclosure in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a perspective view of an electrical connector in accordance with a first embodiment of the present disclosure with an outer shell removed therefrom;

FIG. 2 is an exploded view of the electrical connector shown in FIG. 1;

FIG. 3 is an exploded view of an upper housing and a lower housing;

FIG. 4 is a perspective view of a metallic grounding plate;

FIG. 5 is an exploded view of a metallic inner shell with a top shell separated from a bottom shell;

FIG. 6 is a perspective view of another electrical connector in accordance with a second embodiment of the present disclosure with an outer shell removed therefrom;

FIG. 7 is an exploded view of the electrical connector shown in FIG. 6; and

FIG. 8 is a perspective view of a metallic inner shell shown in FIG. 7.

### DETAILED DESCRIPTION OF ILLUSTRATED EMBODIMENTS

Reference will now be made to the drawing figures to describe the embodiments of the present disclosure in detail. In the following description, the same drawing reference numerals are used for the same elements in different drawings.

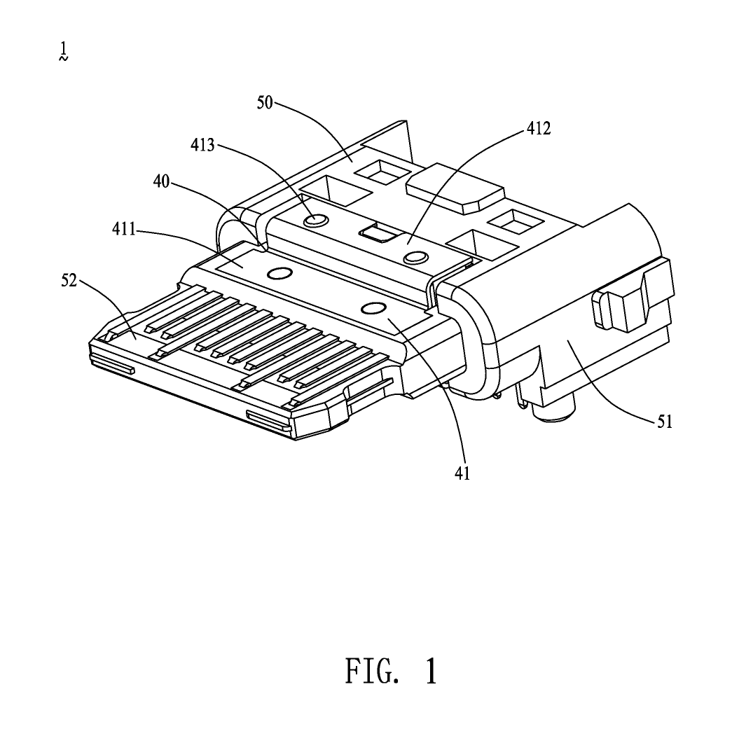

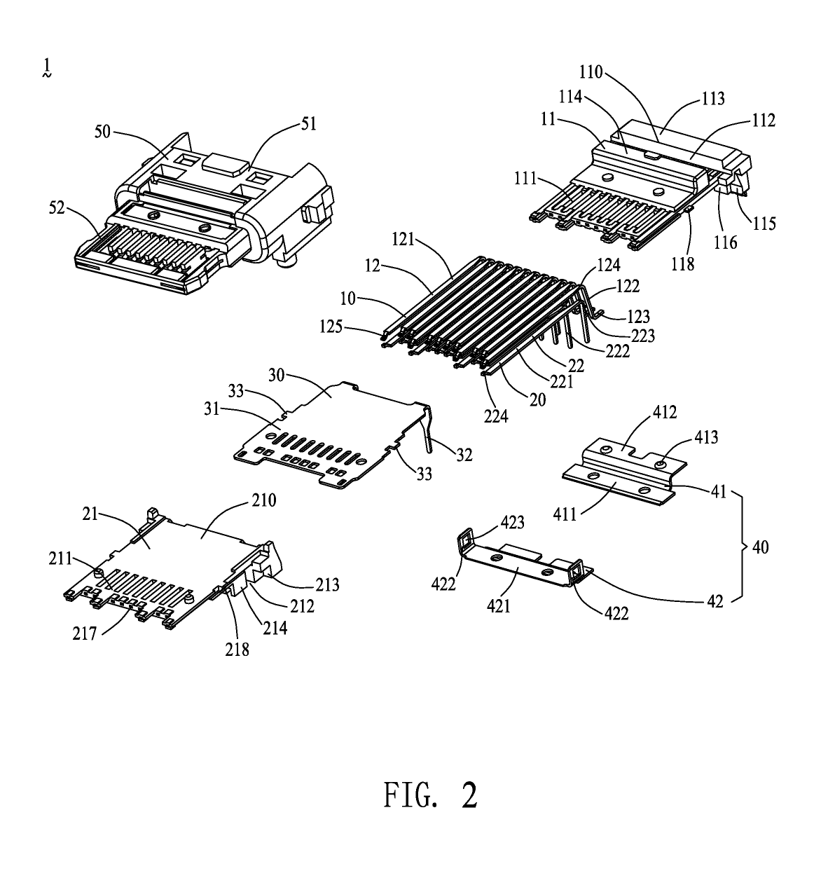

Referring to FIGS. 1 and 2, the present disclosure discloses an electrical connector 1 capably of being mounted to a circuit board (not shown) for receiving a plug connector (not shown). The electrical connector 1 includes an upper contact module 10, a lower contact module 20, a metallic grounding plate 30 positioned between the upper contact module 10 and the lower contact module 20, a metallic inner shell 40 associated with the upper contact module 10 and the lower contact module 20, an outer insulative housing 50 inject-molded over the upper and the lower contact modules 10, 20, and a metallic outer shell (not shown) enclosing the outer insulative housing 50.

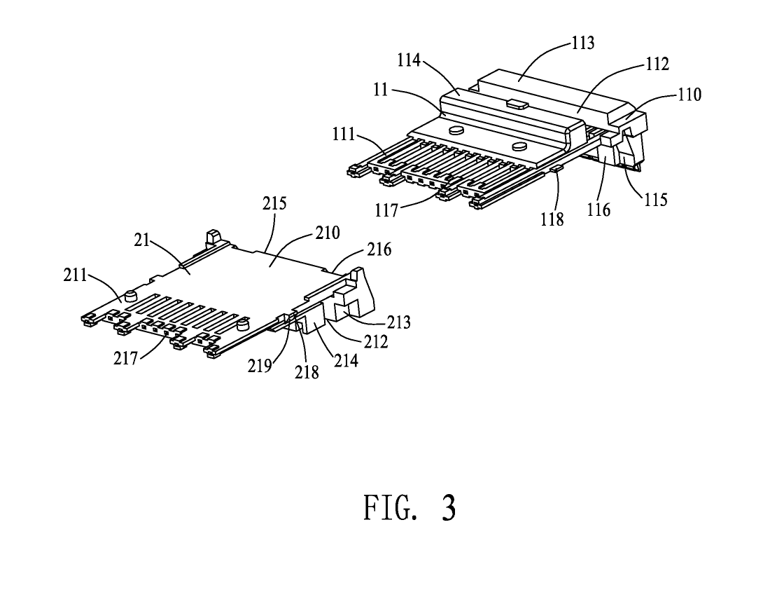

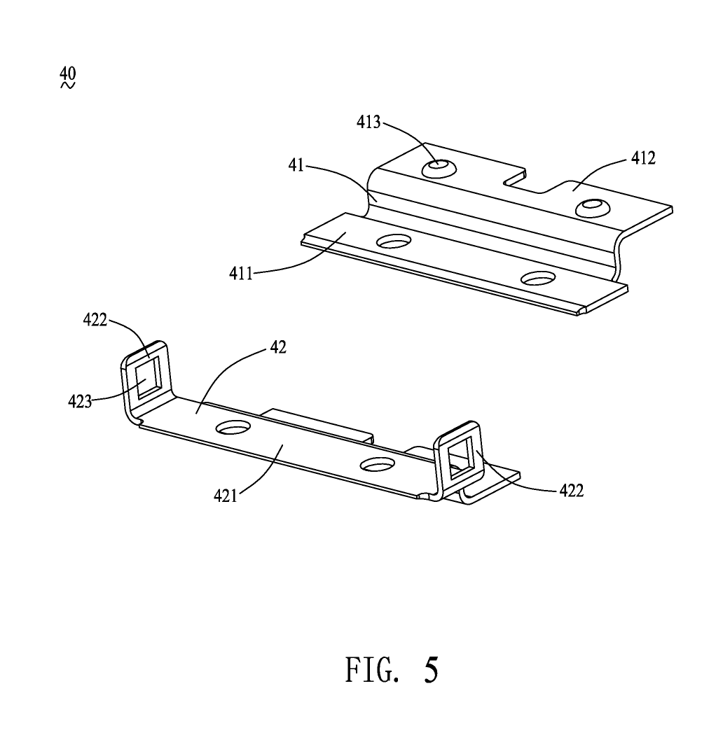

Referring to FIGS. 1 to 5, according to the illustrated embodiment of the present disclosure, the upper contact module 10 includes a plurality of upper contacts 12, a metallic top shell 41 separated from the upper contacts 12 and an upper housing 11 inject-molded over the upper contacts 12 and the top shell 41. The lower contact module 20 includes a plurality of lower contacts 22, a lower housing 21 inject-molded with the lower contacts 22 and a metallic bottom shell 42 attached to a bottom side of the lower housing 21. According to the illustrated embodiment of the present disclosure, the grounding plate 30 is also inject-molded in the lower housing 21.

The upper housing 11 includes an upper base portion 110 and an upper tongue portion 111 extending forwardly from the upper base portion 110. The thickness of the upper base portion 110 is larger than the upper tongue portion 111. The upper base portion 110 includes a recess 112 opposite to the lower housing 21. The upper base portion 110 is divided into a rear portion 113 and a front portion 114 by the recess 112. The front portion 114 is thicker than the upper tongue portion 111.

The rear portion 113 includes a mating surface 115 for mating with the lower housing 21 and a pair of blocks 116 protruding from the mating surface 115. The upper housing 11 also includes a plurality of upper passageways 117 for receiving the upper contacts 12. The upper passageways 117 extend through the upper base portion 110 and the upper tongue portion 111 along a front to back direction. The upper passageways 117 are exposed to the air. Besides, the upper tongue portion 111 includes a pair of first protrusions 118 located at opposite sides thereof.

The lower housing 21 includes a lower base portion 210 and a lower tongue portion 211 extending forwardly from the lower base portion 210. The thickness of the lower base portion 210 is larger than the lower tongue portion 211. The lower base portion 210 includes a recess 212 opposite to the upper housing 11. The lower base portion 210 is divided into a rear portion 213 and a front portion 214 by the recess 212. The front portion 214 is thicker than the lower tongue portion 211.

The rear portion 213 includes a mating surface 215 for mating with the mating surface 115 and a pair of recesses 216 recessed from the mating surface 215 for receiving the blocks 116. The lower housing 21 also includes a plurality of lower passageways 217 for receiving the lower contacts 22. The lower passageways 217 extend through the lower base portion 210 and the lower tongue portion 211 along the front to back direction. The lower passageways 217 are exposed to the air. Besides, the lower tongue portion 211 includes a pair of second protrusions 218 located at opposite sides thereof. The first protrusions 118 and corresponding second protrusions 218 are in alignment with each other along a vertical direction. Besides, the second protrusion 218 includes an inclined guiding surface 219 towards the bottom surface of the lower housing 21.

The upper contacts 12 are arranged in a side-by-side manner. Each upper contact 12 includes an upper contacting portion 121 exposed to the air for mating with the plug connector, a slant portion 122 extending slantwise from the upper contacting portion 121, an upper soldering portion 123 extending horizontally from the slant portion 122, and an upper connecting portion 124 connected between the upper contacting portion 121 and the slant portion 122. The upper contacting portions 121 are received in the upper passageways 117. Each upper contacting portion 121 includes an upper protrusion 125 bent downwardly from a front end thereof. The upper protrusions 125 are embedded in the upper housing 11 for fixation when the upper housing 11 is inject-molded with the upper contacts 12. The upper soldering portions 123 are so-called SMT types and are arranged in a single row for being easily soldered onto a circuit board.

The lower contacts 22 are arranged in a side-by-side manner. Each lower contact 22 includes a lower contacting portion 221 exposed to the air for mating with the plug connector, a lower soldering portion 222 bent downwardly for being mounted to the circuit board, and a lower connecting portion 223 connected between the lower contacting portion 221 and the lower soldering portion 222. The lower contacting portions 221 are received in the lower passageways 217. Each lower contacting portion 221 includes a lower protrusion 224 bent upwardly from a front end thereof. The lower protrusions 224 are embedded in the lower housing 21 for fixation when the lower housing 21 is inject-molded with the lower contacts 22. The lower soldering portions 222 are so-called Through Hole types and are arranged in two rows for being soldered through the circuit board. Of course, the arrangement of the upper soldering portions 123 and the lower soldering portions 222 can be designed in other types according to different requirements. For example, the lower soldering portions 222 can also be arranged in a single row and/or the lower soldering portions 222 can also be designed as SMT types.

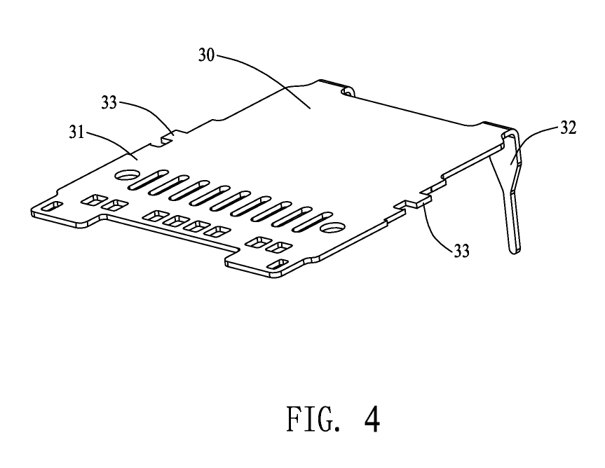

Referring to FIG. 4, the metallic grounding plate 30 is stamped from a metal sheet and located between the upper contact module 10 and the lower contact module 20 for reducing signal interference between the upper contacts 12 and the lower contacts 22. The grounding plate 30 includes a flat body portion 31 and a pair of soldering legs 32 extending downwardly from the body portion 31 for being soldered to the circuit board. The grounding plate 30 can also reinforce the strength of the outer insulative housing 50. The body portion 31 includes a pair of third protrusions 33 on lateral sides thereof. The third protrusions 33 are sandwiched by the first protrusions 118 and the second protrusions 218. Besides, the first protrusions 118, the second protrusions 218 and the third protrusions 33 are aligned with each other along the vertical direction.

The width of the body portion 31 is larger than the upper and the lower contact modules 10, 20. As a result, the body portion 31 extends sidewardly beyond the upper and the lower contact modules 10, 20. Besides, the body portion 31 extends forwardly beyond the upper housing 11 and the lower housing 21.

The inner shell 40 is associated with the upper contact module 10 and the lower contact module 20. According to the first embodiment of the present disclosure, the inner shell 40 includes a top shell 41 covering the upper contact module 10 and a bottom shell 42 covering the lower contact module 20. The top shell 41 and the bottom shell 42 are separately made and assembled together. According to the illustrated embodiment of the present disclosure, the top shell 41 and the bottom shell 42 are separately molded for reducing cost and easy manufacture. The top shell 41 includes a flat mounting section 411 and an elevated section 412 extending backwardly from the mounting section 411. The elevated section 412 includes a plurality of embosses 413 for connecting the top shell 41 and the outer shell. The bottom shell 42 includes a bottom section 421 and a pair of locking arms 422 extending upwardly from lateral sides of the bottom section 421. Each locking arm 422 defines a slot 423 to receive the first protrusion 118, the second protrusion 218 and the third protrusion 33, thereby combining the upper contact module 10 with the lower contact module 20.

The outer insulative housing 50 includes an outer base 51 and an outer tongue portion 52 extending from the outer base 51. The upper contacting portions 121 of the upper contacts 12 and the lower contacting portions 221 of the lower contacts 22 are exposed on upper and lower surfaces of the outer tongue portion 52. Besides, at least part of the grounding plate 30 is exposed to the air for easily contacting the plug connector for grounding.

A method for making the electrical connector 1 includes the following steps:
S1) providing a plurality of upper contacts 12 and a metallic top shell 41, and then inject-molding an upper housing 11 over the upper contacts 12 and the top shell 41 so as to form an upper contact module 10;
S2) providing a plurality of lower contacts 22 and a metallic grounding plate 30, and then inject-molding a lower housing 21 over the lower contacts 22 and the metallic grounding plate 30 so as to form a lower contact module 20;
S3) combining the upper contact module 10 and the lower contact module 20 together with the metallic grounding plate 30 positioned between the upper contacts 12 and the lower contacts 22;
S4) providing a metallic bottom shell 42 to lock with the top shell 41 in order to combine the upper contact module 10 with the lower contact module 20;
S5) inject-molding an outer insulative housing 50 over the upper contact module 10, the lower contact module 20 and the metallic bottom shell 42; and
S6) providing a metallic outer shell (not shown) enclosing the outer insulative housing 50.

Of course, in other manufacturing methods, the grounding plate 30 can also be separately molded from the lower contact module 20, and the top shell 41 can also be separately molded from the upper contact module 10. For example, such method may include the following steps:
S1) providing a plurality of upper contacts 12 and then inject-molding an upper housing 11 over the upper contacts 12 so as to form an upper contact module 10;
S2) providing a plurality of lower contacts 22 and then inject-molding a lower housing 21 over the lower contacts 22 so as to form a lower contact module 20;
S3) providing a metallic grounding plate 30 and then sandwiching metallic grounding plate 30 between the upper contact module 10 and the lower contact module 20 so as to form a first assembly;
S4) providing a metallic inner shell 40 associated with the upper contact module 10 and the lower contact module 20; and
S5) inject-molding an outer insulative housing 50 over the upper contact module 10, the lower contact module 20 and the metallic inner shell 40.

In the step S4, the inner shell 40 includes a top shell 41 attached to a top side of the upper contact module 10 in order to form a second assembly, and a bottom shell 42 for locking with the first assembly and the second assembly.

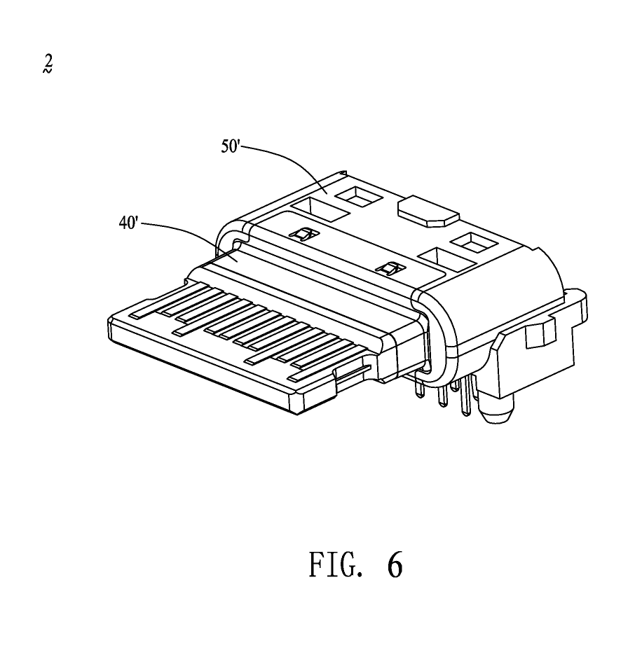

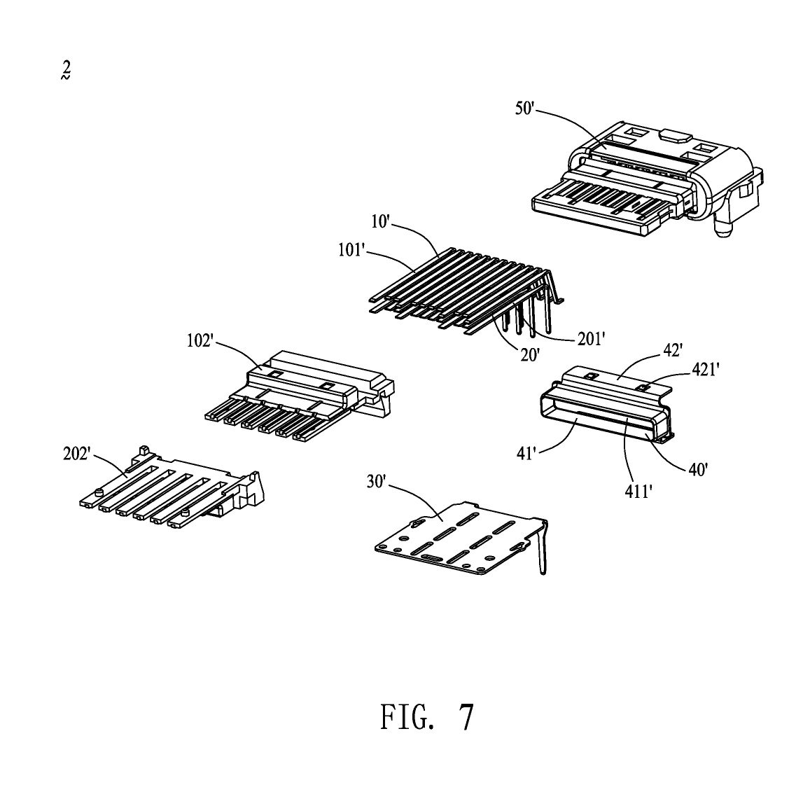

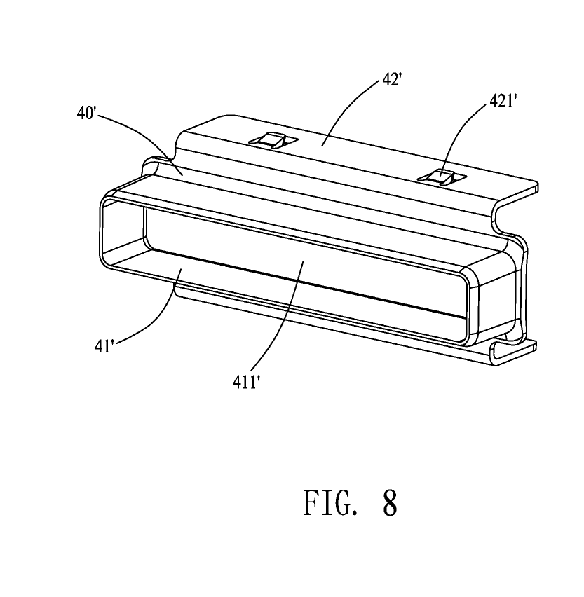

FIGS. 6 to 8, the embodiment of the present disclosure discloses another electrical connector 2 which includes an upper contact module 10′, a lower contact module 20′, a metallic grounding plate 30′ positioned between the upper contact module 10′ and the lower contact module 20′, a metallic inner shell 40′ attached to the upper contact module 10′ and the lower contact module 20′, an outer insulative housing 50′ inject-molded over the upper and the lower contact modules 10′, 20′, and a metallic outer shell (not shown) enclosing the outer insulative housing 50′.

In this embodiment, the upper contact module 10′ includes a plurality of upper contacts 101′ and an upper housing 102′ inject-molded over the upper contacts 101′. The lower contact module 20′ includes a plurality of lower contacts 201′ and a lower housing 202′ inject-molded with the lower contacts 201′. The electrical connector 2 is similar to the electrical connector 1. The major difference therebetween is that the inner shell 40′ is unitary of one piece and is integrally assembled to the upper contact module 10′ and the lower contact module 20′.

The inner shell 40′ includes an annular frame 41′ and a pair of elevated sections 42′ extending backwardly from the frame 41′. The frame 41′ defines an opening 411′ through which the upper contact module 10′ and the lower contact module 20′ extend. Each elevated section 42′ includes a pair of elastic tabs 421 for engaging with the outer shell for connection.

A method for making the electrical connector 2 includes the following steps:
S1) providing a plurality of upper contacts 101′ and then inject-molding an upper housing 102′ over the upper contacts 101′ so as to form an upper contact module 10′;
S2) providing a plurality of lower contacts 201′ and then inject-molding a lower housing 202′ over the lower contacts 201′ so as to form a lower contact module 20′;
S3) providing a metallic grounding plate 30′ and then sandwiching metallic grounding plate 30′ between the upper contact module 10′ and the lower contact module 20′;
S4) providing a metallic inner shell 40′ covering the upper contact module 10′ and the lower contact module 20′; and
S5) inject-molding an outer insulative housing 50′ over the upper contact module 10′, the lower contact module 20′ and the metallic inner shell 40′.

Comparing with prior arts, the electrical connectors 1, 2 according to the present disclosure include at least three inject-molding processes, which will simplify the stamping difficult of the inner shells 40, 40′ and is easily for manufacturing. Besides, when the electrical connectors 1, 2 are manufactured, the inner shells 40, 40′ are exposed to the air and are coplanar with the outer insulative housing 50, 50′, for example, shown in FIG. 6.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

What is claimed is:

1. A method for making an electrical connector comprising steps of:
S1) providing a plurality of upper contacts and inject-molding an upper housing over the upper contacts so as to form an upper contact module;
S2) providing a plurality of lower contacts and inject-molding a lower housing over the lower contacts so as to form a lower contact module; and
S3) inject-molding an outer insulative housing over the upper contact module and the lower contact module.

2. The method as claimed in claim 1, further comprising following steps before the step S3:
S21) providing a metallic grounding plate sandwiched between the upper contact module and the lower contact module; and
S22) providing a metallic inner shell enclosing the upper contact module and the lower contact module.

3. The method as claimed in claim 1, further comprising following steps before the step S3:
S21) providing a metallic grounding plate attached to a top side of the lower contact module so as to form a first assembly;
S22) providing a metallic top shell attached to a top side of the upper contact module so as to form a second assembly; and
S23) providing a metallic bottom shell to consolidate the first assembly and the second assembly.

4. The method as claimed in claim 1, further comprising following steps before the step S3:
S21) providing a metallic bottom shell to consolidate the upper contact module with the lower contact module.

5. The method as claimed in claim 4, wherein the upper contact module further comprises a metallic top shell which is separate from the upper contacts before inject-molding the upper housing, the upper housing being inject-molded with the metallic top shell and the upper contacts simultaneously; the lower contact module further comprises a metallic grounding plate which is separate from the lower contacts before inject-molding the lower housing, the lower housing being inject-molded with the metallic grounding plate and the lower contacts simultaneously.

6. The method as claimed in claim 3, wherein the metallic grounding plate comprises a flat body portion positioned between the upper contacts and the lower contacts, and a pair of soldering legs extending downwardly from the flat body portion for being soldered to a circuit board.

7. The method as claimed in claim 6, wherein the flat body portion extends forwardly beyond the upper housing and the lower housing.

8. The method as claimed in claim 6, wherein the upper housing comprises a first protrusion extending sidewardly, the lower housing comprises a second protrusion extending sidewardly, and the flat body portion comprises a third protrusion sandwiched by the first protrusion and the second protrusion, the first protrusion, the second protrusion and the third protrusion being aligned with each other along a vertical direction, the metallic bottom shell comprising a slot to jointly receive the first protrusion, the second protrusion and the third protrusion.

9. The method as claimed in claim 8, wherein the second protrusion comprises an inclined surface for guiding assembly of the metallic bottom shell.

10. The method as claimed in claim 1, further comprising providing a metallic outer shell enclosing the outer insulative housing.

11. The method as claimed in claim 1, wherein the upper housing comprises an upper base and an upper tongue portion extending forwardly from the upper base, the upper tongue portion being thinner than the upper base; the lower housing comprising a lower base and a lower tongue portion extending forwardly from the lower base, the lower tongue portion being thinner than the lower base.

12. A method for making an electrical connector comprising the steps of:
S1) providing a plurality of upper contacts and a metallic top shell, and then inject-molding an upper housing over the upper contacts and the metallic top shell so as to form an upper contact module;
S2) providing a plurality of lower contacts and a metallic grounding plate, and then inject-molding a lower housing over the lower contacts and the metallic grounding plate so as to form a lower contact module;
S3) combining the upper contact module and the lower contact module together with the metallic grounding plate positioned between the upper contacts and the lower contacts;
S4) providing a metallic bottom shell to lock with the metallic top shell in order to consolidate the upper contact module with the lower contact module; and
S5) inject-molding an outer insulative housing over the upper contact module, the lower contact module and the metallic bottom shell.

13. The method as claimed in claim 12, wherein the metallic grounding plate comprises a flat body portion positioned between the upper contacts and the lower contacts, and a pair of soldering legs extending downwardly from the flat body portion for being soldered to a circuit board.

14. The method as claimed in claim 13, wherein the flat body portion extends forwardly beyond the upper housing and the lower housing.

15. The method as claimed in claim 12, wherein the upper housing comprises a first protrusion extending sidewardly, the lower housing comprises a second protrusion extending sidewardly, and the flat body portion comprises a third protrusion sandwiched by the first protrusion and the second protrusion, the first protrusion, the second protrusion and the third protrusion being aligned with each other along a vertical direction, the metallic bottom shell comprising a slot to jointly receive the first protrusion, the second protrusion and the third protrusion.

16. The method as claimed in claim 15, wherein the second protrusion comprises an inclined surface for guiding assembly of the metallic bottom shell.

17. A method for making an electrical connector comprising steps of:
S1) providing a plurality of upper contacts and then inject-molding an upper housing over the upper contacts so as to form an upper contact module;
S2) providing a plurality of lower contacts and then inject-molding a lower housing over the lower contacts so as to form a lower contact module;
S3) providing a metallic grounding plate and then sandwiching the metallic grounding plate between the upper contact module and the lower contact module;
S4) providing a metallic inner shell associated with the upper contact module and the lower contact module; and
S5) inject-molding an outer insulative housing over the upper contact module, the lower contact module and the metallic inner shell.

18. The method as claimed in claim 17, wherein in the step S4, the metallic inner shell comprises a top shell and a bottom shell separately made from each other, the top shell being attached to a top side of the upper contact module, the bottom shell being attached to a bottom side of the lower contact module, the top shell and the bottom shell being lockable with other in order to consolidate the upper contact module with the lower contact module.

19. The method as claimed in claim 18, wherein the upper housing comprises a first protrusion extending sidewardly, the lower housing comprises a second protrusion extending sidewardly, and the metallic grounding plate comprises a third protrusion sandwiched by the first protrusion and the second protrusion, the first protrusion, the second protrusion and the third protrusion being aligned with each other along a vertical direction, the metallic bottom shell comprising a slot to jointly receive the first protrusion, the second protrusion and the third protrusion.

20. The method as claimed in claim 17, wherein in the step S4, the metallic inner shell is unitary of one piece and comprises an annular frame through which the upper contact module and the lower contact module extend.
